(19) United States
(12) Patent Application Publication
(10) Pub. No.: US 2026/0244883 A1
(43) Pub. Date: Aug. 20, 2026

(54) MULTIPLE NFC ANTENNA ARRAY AND USER DEVICE DETECTION

(71) Applicant: Visa International Service Association, San Francisco, CA (US)

(72) Inventors: Mustafa Top, San Ramon, CA (US); Yuexi Chen, Foster City, CA (US)

(73) Assignee: Visa International Service Association, San Francisco, CA (US)

(21) Appl. No.: 19/161,011

(22) PCT Filed: Mar. 1, 2024
(86) PCT No.: PCT/US2024/017974

§ 371 Date: Aug. 29, 2025

Related U.S. Application Data
(60) Provisional application No. 63/487,655, filed on Mar. 1, 2023.

(51) Int. Cl. G06K 7/10; H01Q 1/22; H01Q 21/00; H04B 5/43

(52) U.S. Cl. CPC G06K 7/10297; G06K 7/10316; H01Q 1/2258; H01Q 21/00; H04B 5/43

(57) ABSTRACT

A communication device is disclosed. The communication device includes a housing comprising an active surface, and a processor associated with the housing. An NFC antenna array is coupled to the processor and is under the active surface of the housing. Each NFC antenna in the NFC antenna array is configured to detect a user device that is proximate to the NFC antenna. The user device comprises a user device NFC antenna and access data. A non-transitory computer readable medium is coupled to the processor. The non-transitory computer readable medium comprises code, executable by the processor, to cause the processor to perform operations. The operations include sequentially polling the NFC antennas in the NFC antenna array until the user device is detected by an NFC antenna in the NFC antenna array and the access data is received by the NFC antenna in the NFC antenna array.

### CROSS-REFERENCES TO RELATED APPLICATIONS

This application is a PCT application which claims priority to U.S. Provisional Application No. 63/487,655, filed on Mar. 1, 2023, which is herein incorporated by reference in its entirety.

### BACKGROUND

If a user wants to use a contactless user device to access a resource, the user may interact the user device with a communication device. For example, the user device can have a first NFC (near field communication) antenna and can tap the user device against a location where a second NFC antenna is located in the communication device. The communication device can be a terminal such as a contactless gate terminal, a contactless payment terminal, a tablet computer, or a laptop computer. When the communication device is a personal device of the user such as the user's laptop computer, the communication device may not have pre-defined markings on its housing to indicate where the user should place the user device to allow it to communicate with the communication device. This can make it difficult for the user to determine where they should place their user device relative to the communication device. In some cases, the communication device can have a display, and software in the communication device can cause the display to display an interaction indicator (e.g., a “tap here” message), which shows the user where to place their user device. In some cases, it is difficult for the user to place the user device near the interaction indicator (e.g., the user is unaware of where the first NFC antenna is in their user device). Further, different manufacturers of communication devices may have NFC antennas in different locations, and any software that displays interaction indicators will need to know those locations. This can be difficult to do, given the number of possibilities of NFC antenna locations in the various types of communication devices.

Embodiments of the disclosure address this problem and other problems individually and collectively.

### BRIEF SUMMARY

One embodiment of the invention includes a communication device comprising: a housing comprising an active surface; a processor associated with the housing; an NFC antenna array coupled to the processor and under the active surface of the housing, each NFC antenna in the NFC antenna array configured to detect a user device that is proximate to the NFC antenna, the user device comprising a user device NFC antenna and access data; and a non-transitory computer readable medium coupled to the processor, the non-transitory computer readable medium comprising code, executable by the processor, to cause the processor to perform operations comprising, sequentially polling the NFC antennas in the NFC antenna array until the user device is detected by an NFC antenna in the NFC antenna array and the access data is received by the NFC antenna in the NFC antenna array.

Another embodiment of the invention includes a method of using a communication device comprising a housing with an active surface, and a processor associated with the housing, an NFC antenna array coupled to the processor and under the active surface of the housing, the NFC antenna array comprising a plurality of NFC antennas, the method comprising: sequentially polling the NFC antennas in the NFC antenna array until the user device is detected by an NFC antenna in the NFC antenna array; and receiving, by the communication device via the NFC, the access data from the user device.

Another embodiment of the invention includes a system comprising: a user device; and a communication device comprising, a housing comprising an active surface, a processor associated with the housing, an NFC antenna array coupled to the processor and under the active surface of the housing, each NFC antenna in the NFC antenna array configured to detect the user device what the user device is proximate to the NFC antenna, the user device comprising a user device NFC antenna and access data, and a non-transitory computer readable medium coupled to the processor, the non-transitory computer readable medium comprising code, executable by the processor, to cause the processor to perform operations comprising, sequentially polling the NFC antennas in the NFC antenna array until the user device is detected by an NFC antenna in the NFC antenna array and the access data is received by the NFC antenna in the NFC antenna array.

These and other embodiments are described in further detail below.

### Terms

Before discussing specific embodiments of the invention, some descriptions of some terms may be helpful.

A “user” may include an individual. In some embodiments, a user may be associated with one or more personal accounts and/or user devices. The user may also be referred to as a cardholder, account holder, or consumer in some embodiments.

A “user device” may be any suitable device that is operated by a user. Suitable user devices can be portable, and can communicate with external entities such as access devices. Examples of user devices include cards that have data stored on them, mobile phones, laptop computers, transponders, wearable devices such as smart watches, automobiles with remote communication capabilities, access cards, smart media, etc. A payment device may be an example of a user device.

A “payment device” may refer to a device that may be used to conduct a financial transaction, such as to provide payment information to a merchant. A payment device may be in any suitable form. For example, suitable payment devices can be hand-held and compact so that they can fit into a consumer's wallet and/or pocket (e.g., pocket-sized). They may include smart cards, magnetic stripe cards, keychain devices (such as the Speedpass™ commercially available from Exxon-Mobil Corp.), etc. If the payment device is in the form of a debit, credit, or smartcard, the payment device may also optionally have features such as magnetic stripes. Such devices can operate in either a contact or contactless mode.

A “communication device” may be a device that includes one or more electronic components (e.g., an integrated chip) that can communicate with another device. For example, a communication device can be a computing device that includes at least one processor coupled to a memory that stores instructions or code for execution by the processor. A “portable communication device” can be a communication device that can be transported and operated by a user. A portable communication device may provide remote communication capabilities to a network. A portable communication device can be configured to transmit and receive data or communications to and from other devices. A portable communication device may be in the form of a mobile device such as a mobile phone (e.g., smart phone, cellular phone, etc.), tablets, portable media player, personal digital assistant devices (PDAs), wearable computing device (e.g., watch), health monitoring device, electronic reader device, etc., or in the form of a card (e.g., smart card) or a fob, etc. Examples of portable communication devices may also include portable computing devices (e.g., laptops, netbooks, ultrabooks, etc.). A portable communication device may also be in the form of a vehicle (e.g., an automobile), or be integrated as part of a vehicle (e.g., an infosystem of a vehicle).

A “resource” can be something of value to a user. A resource, for example, can include digital items and/or physical items. A resource can be an obtainable item. A resource can be owned by an entity. A resource can be a physical item such as goods. A resource can be a service that is provided by a merchant. A resource can be a digital item such as non-fungible tokens, secure data, etc. Another example of a resource is access to a secure or otherwise access-controlled location.

A “resource provider” may be an entity that can provide a resource such as goods, services, information, and/or access to a location (e.g., a parking space, a transit terminal, etc.). Examples of resource providers include merchants, governmental authorities, secure data providers, etc. A resource provider may operate one or more resource provider computers.

A “resource provider computer” may include any system associated with a resource provider. In some embodiments, the resource provider computer may handle functionality of a mobile application and/or a website associated with the resource provider from which a user may acquire resources.

An “authorization entity” may be an entity that authorizes a request. Examples of an authorization entity may be an issuer, a governmental agency, a document repository, an access administrator, etc. An authorization entity may operate an authorization entity computer.

An “issuer” may refer to a business entity (e.g., a bank) that issues and optionally maintains an account for a user. An issuer may also issue payment credentials stored on a user device, such as a cellular telephone, smart card, tablet, or laptop to the consumer.

A “processor” may refer to any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

“Access data” may include any suitable data that can be used to access a resource or create data that can access a resource. In some embodiments, access data may be a credential, a token, or some other type of information that can be used to access a resource.

A “credential” may be any suitable information that serves as reliable evidence of worth, ownership, identity, or authority. A credential may be a string of numbers, letters, or any other suitable characters that may be present or contained in any object or document that can serve as confirmation. User credential examples can be a primary account number, driver's license ID, social security number, etc.

“Payment credentials” may include any suitable information associated with an account (e.g., a payment account and/or payment device associated with the account). Such information may be directly related to the account or may be derived from information related to the account. Examples of account information may include a PAN (primary account number or “account number”), username, expiration date, CVV (card verification value), dCVV (dynamic card verification value), CVV2 (card verification value 2), CVC3 card verification values, etc. CVV2 is generally understood to be a static verification value associated with a payment device. CVV2 values are generally visible to a user (e.g., a consumer), whereas CVV and dCVV values are typically embedded in memory or authorization request messages and are not readily known to the user (although they are known to the issuer and payment processors). Payment credentials may be any information that identifies or is associated with a payment account. Payment credentials may be provided in order to make a payment from a payment account. Payment credentials can also include a username, an expiration date, a gift card number or code, and any other suitable information.

A “token” may be a substitute value for a credential. A token may be a string of numbers, letters, or any other suitable characters. A token may be bound to one or more devices (e.g., a user device). Examples of tokens include access tokens such as payment tokens, data that can be used to access secure systems or locations, etc.

### BRIEF DESCRIPTION OF THE DRAWINGS

FIG. 1 illustrates a system with an NFC antenna array to be used for detecting and communicating with a user device.

FIG. 2 shows a block diagram of a communication device according to an embodiment.

FIG. 3 illustrates an NFC antenna array to be used for detecting and communicating with a user device.

FIG. 4 shows a flow diagram illustrating methods according to embodiments of the invention.

FIG. 5 shows a block diagram of a system according to an embodiment.

### DETAILED DESCRIPTION

A communication device is disclosed. The communication device includes a housing comprising an active surface, and a processor associated with the housing. An NFC antenna array is coupled to the processor and is under the active surface of the housing. Each NFC antenna in the NFC antenna array is configured to detect a user device that is proximate to the NFC antenna. The user device comprises a user device NFC antenna and access data. A non-transitory computer readable medium is coupled to the processor. The non-transitory computer readable medium comprises code, executable by the processor, to cause the processor to perform operations. The operations include sequentially polling the NFC antennas in the NFC antenna array until the user device is detected by an NFC antenna in the NFC antenna array and the access data is received by the NFC antenna in the NFC antenna array.

Embodiments of the invention can allow a user to tap or otherwise interact their NFC capable user device with a larger area of an NFC capable communication device. The larger area can increase the chances that the user device interaction with the communication device is successful. For instance, by providing a larger area for the user to tap or otherwise interact their user device with a communication device, the user is much less likely to tap or otherwise interact their user device with an area of the communication device that cannot receive an NFC signal from the user device. Further, in some embodiments, the area that can interact with and receive data from a user device can include an entire display screen surface of a display of the communication device. The user can tap their user device anywhere on the display screen instead of just a small area of the display screen. This not only reduces the chance that the interaction will not be successful. It also allows software that provides instruction to the user regarding how to interact their user device with the communication device to be less precise. For example, instead of having to provide software that instructs the user to tap their user device at a specific location (e.g., the bottom corner) on a display screen of a communication device, the software can cause the communication device to display a message such as “tap anywhere on the screen” to the user.

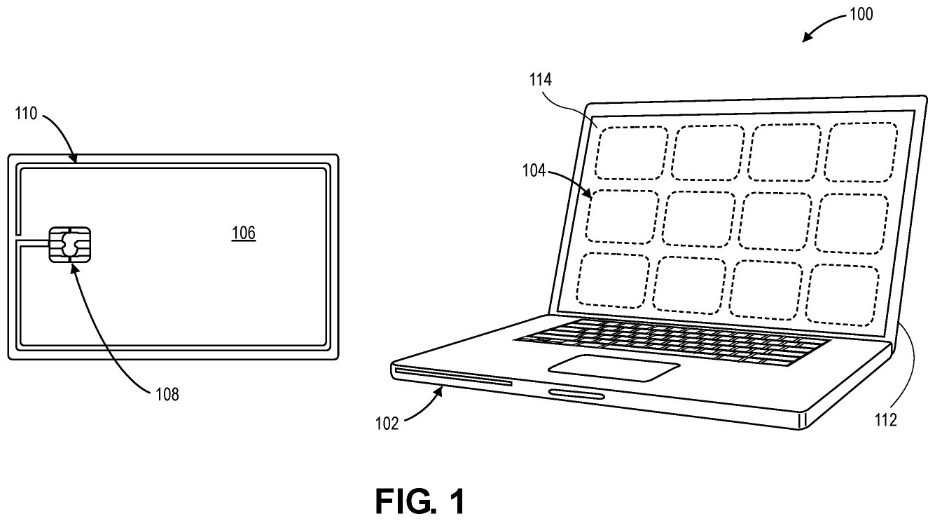

FIG. 1 illustrates a system 100 comprising a communication device 102 and a user device 106 which can interact with and provide access data to the communication device 102. The communication device 102 comprises an NFC antenna array 104, which can be used to detect and communicate with the user device 106. The user device 106 may be within proximity of the communication device 102 such that an NFC antenna in the NFC antenna array 104 can communicate with the user device 106 via a user device NFC antenna 110. The user device NFC antenna 110 may be a radio frequency (RF) antenna (e.g., using a 13.56 MHz carrier frequency) and may be a loop antenna.

The communication device 102 may include a housing 112 which includes an active surface 114. The active surface 114 can include a display screen surface in this embodiment. The active surface 114 can be a surface that is capable of detecting the user device 106 through an NFC interaction. In other embodiments, the active surface 114 does not need to correspond to a display screen surface, but could be a surface such as a solid surface of the housing 112 or it could be a surface such as a tabletop surface.

The NFC antenna array 104 may be enclosed (e.g., partially or completely) by the housing 112 and be included under the active surface 114 as shown by the dotted lines. The NFC antenna array 104 may include a plurality of NFC antennas that can be sequentially polled, and an optimal NFC antenna in the NFC antenna array 104 can detect the user device 106 at an arbitrary location on the active surface 114 that is chosen by the user. Once detected, the user device 106 may provide access data to the communication device 102 via the optimal NFC antenna and the user device NFC antenna 110 in the user device 106.

The user device 106 may include a chip 108 in communication with the user device NFC antenna 110. The chip 108 can store the access data and other information. If the user device 106 is in the form of a card, it may have printed or embossed information such as a name of the user and an account number associated with the user device 106.

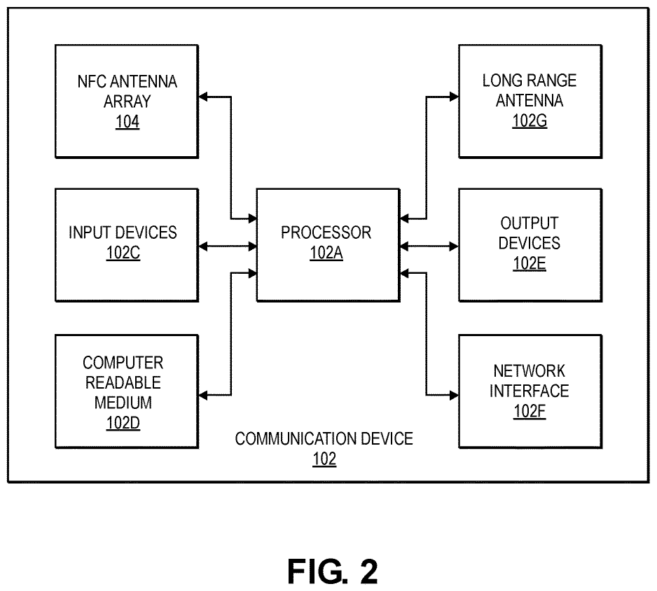

FIG. 2 shows a block diagram of a communication device 102 according to an embodiment.

Communication device 102 includes a processor 102A. The processor 102A may be any suitable processor operable to carry out instructions on the communication device 102. The processor may be associated with a housing of the communication device 102. For example, the processor 102A may be enclosed by the housing of the communication device 102. The processor 102A may be coupled to other components of the communication device 102 including an NFC antenna array 104, input devices 102C, a non-transitory computer readable medium 102D, output devices 102E, a network interface 102F, and a long range antenna 102G such as cellular antenna.

The NFC antenna array 104 may include a plurality of NFC antennas, where each NFC antenna in the NFC antenna array is configured to detect a user device proximate (e.g., within range of sensing a wireless signal) to the NFC antenna in the NFC antenna array 104. Each NFC antenna in the NFC antenna array 104 may be a loop antenna. The detection may occur after polling commands are sent sequentially, by the processor 102A, to the individual NFC antennas in the NFC antenna array 104. In some embodiments, an optimal NFC antenna is determined, and the optimal NFC antenna is used to communicate with the user device and receive access data from the user device. The detection of the user device by each of the NFC antennas in the NFC antenna array 104 may be represented by a voltage signal. A higher voltage signal may represent a better and/or stronger wireless communication connection between the NFC antenna in the NFC antenna array 104 and the user device NFC antenna. The highest detected voltage after polling by an NFC antenna in the NFC antenna array 104 may indicate that the NFC antenna is the optimal NFC antenna in the NFC antenna array 104 for the current user device interaction.

The input devices 102C may be a user interface for receiving input from a user. The communication device 102 may include any number of input devices 102C. Example input devices may be keyboards, microphones, touchscreens, mousepads, accelerometers, etc.

The computer readable medium 102D may comprise code, executable by the processor 102A for performing operations described herein. The operations may comprise: sequentially polling the NFC antennas in the NFC antenna array until the user device is detected by an NFC antenna in the NFC antenna array; and receiving, by the communication device via the NFC, the access data from the user device.

The output devices 102E may be a user interface for presenting output (e.g., to a user). The communication device 102 may include any number of output devices 102E. Example output devices may be displays, speakers, haptics, etc.

The network interface 102F include an interface that can allow the communication device 102 to communicate with external computers. Some examples of the network interface 105 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 102F may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 102F and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

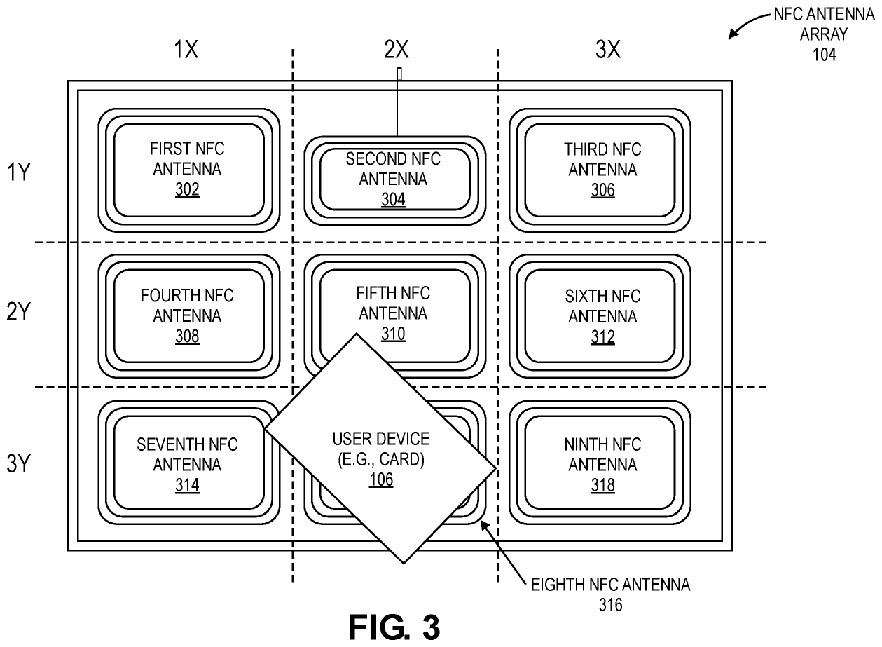

FIG. 3 illustrates a schematic diagram of an NFC antenna array 104 to be used for detecting a user device 106 and communicating with the user device 106 according to an embodiment of the invention.

The NFC antenna array 104 may include a plurality of NFC antennas, which may have various shapes (e.g., circular, rectangular, etc.) and sizes. In some embodiments, each of the NFC antennas in the NFC antenna array 104 can be of the same general shape and size (e.g., all coils with approximately the same diameter). In some embodiments, the size (in a major dimension) of an NFC antenna in the NFC antenna array 104 is less than 7 inches. In FIG. 3, there are nine NFC antennas: 302, 304, 306, 308, 310, 312, 314, 316, and 318. Other embodiments can have more or less NFC antennas in the NFC antenna array 104.

The NFC antennas in the NFC antenna array 104 can be made of any suitable material. In some embodiments, the NFC antennas in the NFC antenna array 104 can be made of a conductive material such as indium tin oxide (ITO) printed on a transparent substrate. This allows the NFC antenna array to be used with a display screen. In other embodiments, the material of the NFC antennas can be metals such as copper or copper alloys.

The size of the first NFC antenna 302, shape of the first NFC antenna 302, and/or NFC antenna array 104 arrangement, may depend on at least one of: the size of the communication device the NFC antenna is housed in, the shape of an active surface of the communication device, the user device(s) that the communication device is configured to interact with, the NFC antenna configuration of the user device NFC antenna(s), a desired power consumption of the first NFC antenna, a desired power consumption of the NFC antenna array, the expected communication distance between the user device and the first NFC antenna, the shape of the first NFC antenna, the material of the first NFC antenna, the amount of material between the first NFC antenna and the user device, or the type of material between the first NFC antenna and the user device.

As an example, an NFC antenna of the NFC antenna array 104 may be the size of an ID-1 card (i.e., a standard “credit card” size for identification cards defined by ISO/IEC 7810). An NFC antenna of the NFC antenna array 104 may be seven inches long (e.g., along a major dimension of the NFC antenna). For some implementations, the maximum size of an NFC antenna that is part of the NFC antenna array 104 can be seven inches in diameter for a circularly shaped NFC antenna, or the longer side of a rectangular shape. Larger active surfaces may require more NFC antennas in the NFC antenna array.

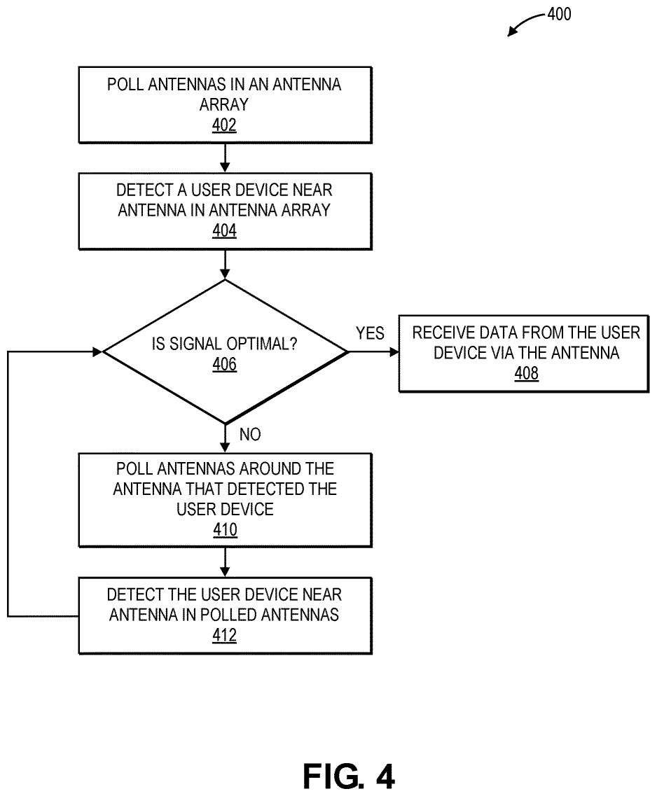

FIG. 4 shows a flow diagram illustrating a method 400 of interfacing a user device with a communication device and determining an optimal NFC antenna in an NFC antenna array to receive data from the user device. The communication device can sequentially poll NFC antennas in the NFC antenna array to find an NFC antenna that can communicate with the user device. If the NFC antenna array is in a rectangular array, then sequentially polling comprises polling each NFC antenna in the NFC array in a row by row or column by column manner.

At 402, one or more NFC antennas of an NFC antenna array may be polled. Polling may occur using EMV (Europay, MasterCard, Visa) contactless reader polling commands, such as a WUPA (Wake Up Polling type A) and/or WUPB (Wake Up Polling type B). The polling commands can be sent by a processor of the communication device to sense a user device (e.g., a card) that is proximate to a field of a respective NFC antenna in the NFC antenna array. In certain embodiments, the WUPA and WUPB polling commands can be sent with approximately 10 to 20-microsecond intervals between each command. In certain embodiments, after sending a polling command, a predetermined amount of time is allowed to pass before sending another polling command. The communication device may have a receiver circuit connected to the NFC antennas of the NFC antenna array and the receiver circuit can be capable of detecting and recording the user device response modulation strength (e.g. a response trigger voltage) with a voltage value per NFC antenna.

In an example, the communication device activates an NFC field of an NFC antenna in the NFC antenna array with a wakeup command, and then waits for 5.1 milliseconds for a nearby user device to power up. The wakeup command may be a WUPA command to detect type A user devices. If no response to the WUPA wakeup command, then after another 5.1 milliseconds, a WUPB command for type B user devices may be sent. Assuming that no user device responds to these commands, the communication device shuts down the field for the NFC antenna. Overall, this process takes about 11.2 milliseconds. The communication device may then activate a different NFC antenna in the NFC antenna array, and the process can continue sequentially through the NFC antennas in the NFC antenna array.

Polling may occur using one or more NFC antennas of the NFC antenna array at a time. Polling may occur in a random order or in a predefined order. Polling may occur until a user device is detected as being proximate to an NFC antenna and the communication signals between the user device and the NFC antenna are sufficiently strong for the NFC antenna to receive access data from the user device.

At 404, the user device may be detected near an NFC antenna of the NFC antenna array. The user device may be detected using either the WUPA and/or the WUPB polling commands. The NFC antenna of the NFC antenna array that detects the user device during polling will measure a voltage signal associated with the response to the polling. A voltage value associated with the voltage signal may be stored in memory of the communication device and associated with the NFC antenna of the NFC antenna array.

At 406, the communication device may determine whether the signal between the NFC antenna that detected the user device and the user device is optimal. In certain embodiments, the NFC signal is optimal when the voltage response associated with the NFC antenna is above a threshold voltage level. In certain embodiments, the NFC signal is optimal when the voltage response associated with the NFC antenna is higher than all other previously polled NFC antennas. For example, the NFC antenna with the highest voltage response of all polled NFC antennas may be the optimal NFC antenna to use for communication with the user device.

In certain embodiments, the NFC antenna in the NFC antenna array that produces the highest voltage signal associated with the response to the polling (globally optimal) or exceeds a threshold voltage value will be determined to be the optimal NFC antenna for use with communicating with the user device.

At 408, if the signal voltage value for the NFC antenna in the NFC antenna array is determined to be optimal at step 406, the user device may communicate with the communication device using the NFC antenna of the NFC antenna array that is associated with the optimal voltage response signal and the user device NFC antenna. The user device may communicate access data to the communication device as described above. Further polling of the NFC and in the NFC antenna array may stop since communication between the user device and the communication has started.

At 406, if the signal associated with the particular NFC antenna is not to be optimal, then the communication device can determine that the signal received by the NFC antenna is too weak to initiate communication with the user device. The detection of the weak signal by the NFC antenna array, however, can indicate that the user device is nearby. An attempt is then made to find a nearby NFC antenna that can produce a better signal voltage value than the currently polled NFC antenna.

At step 410, NFC antennas around the previously polled NFC antenna can be sequentially polled. For example, all NFC antennas surrounding the previously polled NFC antenna that produced the weak signal can be sequentially polled until a stronger voltage signal is obtained and an optimal NFC antenna is identified. This process can repeated as many times as necessary to find a suitable or optimal NFC antenna for the user device to communicate with.

At 412, if the user device is detected near the NFC antennas polled during step 410, the method may perform step 406 again to determine if the NFC antenna that detected the user device is an NFC antenna that has received an optimal signal for communication with the user device. Once the optimal signal is determined, then the NFC antenna is determined and the user device can communicate with the communication device via that NFC antenna as in step 408.

As an example of method 400, a method of polling using the NFC antenna array 104 to detect the user device 106 illustrated in FIG. 3 is described below.

The NFC antenna array 104 in FIG. 3 shows an embodiment that has an NFC antenna array consisting of nine NFC antennas wherein three NFC antennas are in each of the three rows and three NFC antennas are in each of the three columns (in an embodiment, the NFC antenna array can have more or fewer rows and columns). The x-y coordinates of NFC antennas in the NFC antenna array 104 may be defined as 1X, 2X, 3X, . . ., NX, across the columns to represent an antenna position along an x-axis and be defined as 1Y, 2Y, 3Y, . . . , nY across the rows to represent an antenna position along a y-axis, wherein each row and column may contain any number of NFC antennas that are represented by N and n, respectively. Therefore, the number of NFC antennas within an antenna array may be represented by the number of NFC antennas in the first X-axis array multiplied by the number of NFC antennas in the second y-axis array (e.g., N*n).

In the method, the processor sends a pair of WUPA and WUPB polling commands starting from the first NFC antenna 302 (at (1X,1Y)). As soon as the polling commands time out (e.g., no response received by the receiver circuit of the first NFC antenna 302), the method switches to an adjacent NFC antenna (e.g., the second NFC antenna 304 or the fourth NFC antenna 308) before then sending another pair of WUPA and WUPB polling commands using the adjacent NFC antenna. The processor will repeat this process until the communication device receives a voltage response from an NFC antenna at a responsive position XY. The voltage response from the NFC antenna at some XY position may represent a high possibility of communication with the user device using that particular NFC antenna or one of the adjacent NFC antennas around it. To find the optimal NFC antenna (e.g., the NFC antenna that would provide the best communication), one of or each of the WUPA and WUPB polling commands may then be sent using nearby NFC antennas to determine if better reception (e.g., (voltage at previous best X, Y)<voltage at current X, Y antenna position) can be obtained by any of the adjacent NFC antennas compared to the currently best NFC antenna's reception.

To further illustrate, the communication device may begin with using the first NFC antenna 302 in an attempt to find the best NFC antenna. The communication device may not obtain a response from the user device using the first NFC antenna 302, causing the communication device to deactivate the first NFC antenna 302 and try again with the adjacent second NFC antenna 304. This process will repeat for the third NFC antenna 306 and the fourth NFC antenna 308 respectively before then reaching the fifth NFC antenna 310. Once the communication device activates the fifth NFC antenna 310 and sends a WUPA and/or WUPB polling command to the fifth NFC antenna 310, a receiver circuit connected to the fifth NFC antenna 310 may detect a voltage response from the fifth NFC antenna 310 having a value (e.g., a voltage value) of V1.

After the receiver receives a valid response from the user device 106 (e.g., a card) via the fifth NFC antenna 310 at position XY, it may disable the fifth NFC antenna 310 at position XY, make the NFC antenna at XY a center NFC antenna, and send a WUPA and/or WUPB polling command via an NFC antenna adjacent to the center NFC antenna, such as NFC antenna at X(Y+1) (the second NFC antenna 304). If no response, it repeats the same for NFC antennas X(Y−1) (the eighth NFC antenna 316), (X+1)Y (the sixth NFC antenna 312), (X−1)Y (the fourth NFC antenna 308), (X+1)(Y+1) (the ninth NFC antenna), and so on to scan all adjacent NFC antennas until a response is found from an adjacent NFC antenna with a voltage that is greater than the voltage at the current center (V1 at the fifth NFC antenna 310, in this example). The new and better (e.g., better communicating, higher voltage inducing) NFC antenna is defined as a new center NFC antenna. Once a new center NFC antenna is established, the process may repeat until no adjacent NFC antenna is more optimal (e.g., there is no better reception, no higher voltage caused) than the current center NFC antenna. Once the optimal NFC antenna is found using the above-described process, the current center NFC antenna is selected to be the communication NFC antenna. The above-described process allows for determining where a user has placed a user device with respect to the active surface/communication landing plane (e.g., a large active surface, a computer screen, a tabletop, etc.).

In certain embodiments, the best NFC antenna of all NFC antennas adjacent to the center NFC antenna is chosen to be the new center NFC antenna. In certain embodiments, the first NFC antenna that is better than the current center NFC antenna is chosen for the new center NFC antenna. In certain embodiments, NFC antennas that have already been polled are not polled again when searching for an optimal NFC antenna to reduce the search time and increase processing efficiency. The order in which adjacent NFC antennas are checked (search patterns) could be carried out: in a specific order, a random order, by checking all adjacent NFC antennas with a Y value higher than the current antenna first, by stopping after finding the first NFC antenna with a higher voltage value than the current NFC antenna, etc. With the benefit of the present disclosure, one of ordinary skill in the art would recognize other search patterns that may be used to find the optimal NFC antenna included in the NFC antenna array for communicating with the user device.

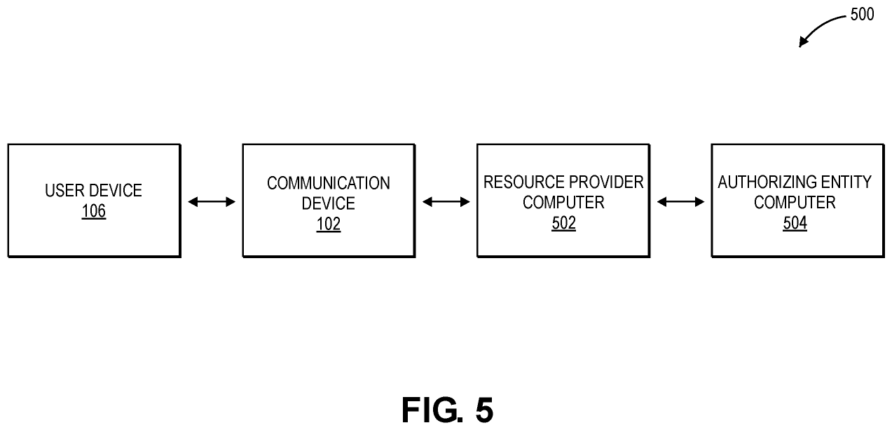

FIG. 5 shows a block diagram of a system 500 according to an embodiment. Each of the devices and computers of system 500 may be in operative communication with each other. For simplicity of illustration, a certain number of components are shown in system 500. It is understood, however, embodiments of the invention may include more or less components that are shown in system 500.

The devices and computers in the system 500 can communicate with one another using a communication network or line (not pictured). The communication network or line can take any suitable form, and may include any one and/or the combination of the following: a direct connection or interconnection; the Internet; a Local Area Network (LAN); a Metropolitan Area Network (MAN); an operating Missions as Nodes on the Internet (OMNI); a cellular network, a secured custom connection; a Wide Area Network (WAN); a wireless network (e.g., employing protocols such as, but not limited to a Wireless Application Protocol (WAP), I-mode, and/or the like); and/or the like. Messages between the computers and devices in system 500 may be transmitted using a communication protocol such as, but not limited to, File Transfer Protocol (FTP); Hypertext Transfer Protocol (HTTP); Secure Hypertext Transfer Protocol (HTTPS); Secure Socket Layer (SSL), ISO (e.g., ISO 8583) and/or the like.

The system includes a user device 106, a communication device 102, a resource provider computer 502, and an authorizing entity computer 504. In certain embodiments, the communication device 102 and the resource provider computer 502 are the same device. The communication device 102 may include an NFC antenna array with a plurality of NFC antennas in an arrangement. At least some of the NFC antennas of the NFC antenna array may be configured to detect the user device 106 when the user device 106 is placed proximate to one or more of the NFC antennas of the NFC antenna array.

A user may use the user device 106 to pay for a good or service at a resource provider such as a merchant. The merchant may operate a resource provider computer 502 and/or a communication device 102. The resource provider computer 502 may communicate with the authorizing entity computer 504 to authorize a transaction with the user device 106. The resource provider computer 502 may communicate with the authorizing entity computer 504 operated by an issuer via a transport computer operated by an acquirer and a processing network such as a payment processing network.

A typical payment transaction flow using a user device 106 at a communication device 102 (e.g., a POS terminal) can be described as follows. A user presents his or her user device 106 (which may be similar to the user device 106 in FIG. 1) to a communication device 102 to pay for an item or service. The user device 106 and the communication device 102 interact such that access data from the user device 106 (e.g., PAN, a payment token, verification value(s), expiration date, etc.) is received by the communication device 102 (e.g., via contact or contactless interface). The communication device 102 can then transmit the data to an external server computer such as the resource provider computer 502. The resource provider computer 502 may then receive this information from the communication device 102 via an external communication interface. The resource provider computer 502 may then generate an authorization request message that includes the information received from the communication device 102 (i.e. information corresponding to the user device 106) along with additional transaction information (e.g., a transaction amount, merchant-specific information, etc.) and electronically transmits this information to the authorizing entity computer 504 (e.g., via a transport computer and processing network) for authorization.

In some embodiments that do not involve financial transactions, the system 500 can allow a user of the user device 106 to access a secure location. In such embodiments, the communication device 102 and/or resource provider computer 502 can grant or deny access to the user, based on interactions with the user device 106. The communication device 102 and/or the resource provider computer 502 can transmit an authorization request message with the transaction data to the authorizing entity computer 504. In such embodiments, the transaction data may include at least a transaction value (e.g., the user has entered the secure location 5 times, a transaction is assigned a value of 40, etc.), and/or an account identifier (e.g., a primary account number (PAN)).

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to certain embodiments of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A communication device comprising:
a housing comprising an active surface;
a processor associated with the housing;
an NFC antenna array coupled to the processor and under the active surface of the housing, each NFC antenna in the NFC antenna array configured to detect a user device that is proximate to the NFC antenna, the user device comprising a user device NFC antenna and access data; and
a non-transitory computer readable medium coupled to the processor, the non-transitory computer readable medium comprising code, executable by the processor, to cause the processor to perform operations comprising,
sequentially polling the NFC antennas in the NFC antenna array until the user device is detected by an NFC antenna in the NFC antenna array and the access data is received by the NFC antenna in the NFC antenna array.

2. The communication device of claim 1, wherein the active surface is a tabletop or a screen on a tablet computer, computer monitor, or laptop computer.

3. The communication device of claim 1, wherein the user device is a card.

4. The communication device of claim 1, wherein polling the NFC antennas in the NFC antenna array until the user device is detected by an NFC antenna in the NFC antenna array and the access data is received by the NFC antenna comprises:
detecting, by a first NFC antenna in the NFC antenna array, the user device; and
polling NFC antennas around the first NFC antenna; and
detecting, by an optimal NFC antenna in the NFC antenna array, the user device, wherein the optimal NFC antenna is the NFC antenna that received the access data.

5. The communication device of claim 1, wherein the NFC antenna array comprises a rectangular array of NFC antennas.

6. The communication device of claim 1, wherein the access data comprises a credential.

7. The communication device of claim 1, wherein the NFC antenna array comprises a rectangular array of NFC antennas, and the NFC antennas are made from a transparent conductive material.

8. The communication device of claim 1, wherein the user device is a phone and the communication device is a laptop computer.

9. The communication device of claim 1, wherein sequentially polling comprises polling each NFC antenna in the NFC array in a row by row or column by column manner.

10. The communication device of claim 1, wherein the operations further comprise:
transmitting, by the communication device, the access data to an external server for processing.

11. A method of using a communication device comprising a housing with an active surface, and a processor associated with the housing, an NFC antenna array coupled to the processor and under the active surface of the housing, the NFC antenna array comprising a plurality of NFC antennas, the method comprising:
sequentially polling the NFC antennas in the NFC antenna array until the user device is detected by an NFC antenna in the NFC antenna array; and
receiving, by the communication device via the NFC, the access data from the user device.

12. The method of claim 11, wherein polling the NFC antennas in the NFC antenna array comprises:
detecting, by a first NFC antenna in the NFC antenna array, the user device; and
polling NFC antennas around the first NFC antenna; and
detecting, by an optimal NFC antenna in the NFC antenna array, the user device, wherein the optimal NFC antenna is the NFC antenna that received the access data.

13. The method of claim 11, wherein polling antennas in the antenna array until the user device comprising the access data is detected comprises:
receiving a signal from a second antenna in the antenna array; and
polling the antennas surrounding the second antenna until an optimal antenna for detecting where the user device is located, wherein the optimal antenna is the antenna array.

14. The method of claim 11, wherein the NFC antenna array is a rectangular array of NFC antennas.

15. The method of claim 11, wherein the operations further comprise:
transmitting, by the communication device, the access device to an external server for processing.

16. A system comprising:
a user device; and
a communication device comprising,
a housing comprising an active surface,
a processor associated with the housing,
an NFC antenna array coupled to the processor and under the active surface of the housing, each NFC antenna in the NFC antenna array configured to detect the user device what the user device is proximate to the NFC antenna, the user device comprising a user device NFC antenna and access data, and
a non-transitory computer readable medium coupled to the processor, the non-transitory computer readable medium comprising code, executable by the processor, to cause the processor to perform operations comprising,
sequentially polling the NFC antennas in the NFC antenna array until the user device is detected by an NFC antenna in the NFC antenna array and the access data is received by the NFC antenna in the NFC antenna array.

17. The system of claim 16, wherein the active surface is a: tabletop or a screen on a tablet computer, computer monitor, or laptop computer.

18. The system of claim 16, wherein the active surface comprises a display surface of a display screen and the array of NFC antennas is under the display screen surface.

19. The system of claim 16, the communication device is a laptop computer.

20. The system of claim 16, wherein the user device is a card.
